(19) United States
(12) Patent Application Publication
(10) Pub. No.: US 2012/0274042 A1
(43) Pub. Date: Nov. 1, 2012

(54) Replaceable and open-able dropout system enabling adjustable width and height

(76) Inventors: Paul Harris, Montreal (CA); Roy Jerome, St-Jean-de-Matha (CA)

(21) Appl. No.: 13/506,494

(22) Filed: Apr. 24, 2012

Related U.S. Application Data
(60) Provisional application No. 61/457,587, filed on Apr. 26, 2011.

(51) Int. Cl. B62K 25/02

(52) U.S. Cl. 280/288

(57) ABSTRACT

The invention describes a portion of a bicycle assembly that allows for a wheel hub width adjustment using replaceable dropouts of varying widths or arrangements with spacers. Alternative forms allow different arrangements for varying the wheel hub assembly without changing the dropout either by moving the dropouts relative to the mounting lugs or having extendable dropout arrangements. In addition, the dropout can have fastener holes at different locations to adjust the height of the bicycle frame relative to the ground. Moreover, the dropout can have additional fastener holes to prevent rotation of the dropout.

### CROSS REFERENCE TO RELATED APPLICATIONS

The present application claims the benefit under 35 U.S.C. section 119 (e) of U.S. Provisional Patent Application No. 61/457,587, titled “Replaceable and Open-able Dropout System Enabling Adjustable Width and Height”, filed Apr. 26, 2011, which is hereby incorporated by reference in its entirety.

### FIELD OF THE INVENTION

The invention relates to a bicycle dropout system, and more particularly, to a replaceable bicycle dropout system enabling installation of an endless belt through a bicycle frame and to accommodate varying hub assembly widths as well as enabling vertical and lateral adjustments to bicycle frame height and length. The replaceable dropout allows user to completely replace a damaged dropout in the event of a crash or replace it for another type to accommodate different gearing options.

### BACKGROUND OF THE INVENTION

U.S. Pat. No. 4,909,529 discloses a bicycle having a belt. However, since belts are manufactured in a continuous loop which cannot be cut so it can be passed through a bicycle frame, it is then necessary to cut or open a gap in the bicycle frame though which the belt can pass. U.S. Pat. No. 7,854,441 discloses a non-replaceable bicycle dropout for installation of a belt through a bicycle frame.

In order to accommodate varying widths of a hub assembly in a bicycle, there needs to be a mechanism to adjust the width of the dropout. The present invention attempts to bridge this gap.

### SUMMARY

The primary aspect of the invention is to provide a replaceable bicycle dropout system enabling installation of an endless belt through a bicycle frame and to accommodate varying hub assembly widths as well as enabling vertical and lateral adjustments to bicycle frame height and length. The invention relates to a bicycle assembly that allows for wheel hub adjustment using replaceable dropouts of varying widths or arrangements with spacers. Alternatively forms allow different arrangements for varying the wheel hub assembly without changing the dropout either by moving the dropout relative to the mounting lugs or having extendable dropout arrangements. In addition, the dropout in the system can have fastener holes at different locations to adjust the height of the bicycle frame relative to the ground. Moreover, the dropout in the system can have additional fastener holes or keys to prevent rotation of the dropout relative to the mounting lugs.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 shows one embodiment of dropout and two ways of achieving hub wheel width adjustability. Range of adjustment is the same on right and left dropout

FIG. 2 shows alternate type with different means of providing Wheel hub width adjustments.

FIG. 3 is of a third type that uses four fasteners instead of two to prevent relative rotation at drop out mounting lug interface.

FIG. 4 shows another type of mount that uses two round rods as part of the dropout system and clamped to frame lugs in a way that permits width adjustment when clamps are opened.

FIG. 5 illustrates an extendable wheel hub width arrangement using a dropout with a spring arrangement.

FIG. 6 illustrates the difference between a left hand dropout and a right hand dropout.

### DETAILED DESCRIPTION OF THE PREFERRED EMBODIMENT

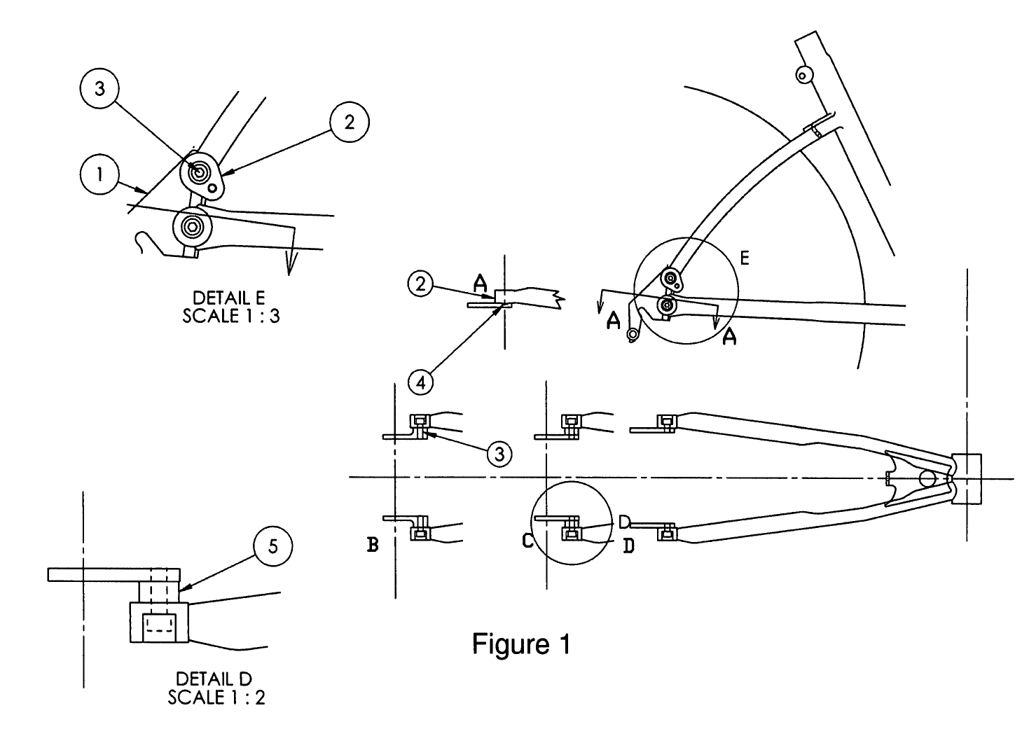

The present invention provides a replaceable bicycle dropout system enabling installation of an endless belt through a bicycle frame and to accommodate varying hub assembly widths as well as enabling vertical and lateral adjustments to bicycle frame height and length. In one aspect the invention comprises of a replaceable part holding the bicycle wheel to the frame, and is referred to as a dropout as shown as 1 in FIG. 1, and a second part, a mounting lug permanently attached to the main bicycle frame shown as 2 in FIG. 1. Different types of fasteners including, but not limited to: bolts, pins, studs, nuts, shoulder screws or tubular nuts, shown as 3 in FIG. 1, can be used to hold and locate these two parts. The act of separating these two parts, the dropout and mounting lug, held together by mechanical fasteners enables, among other functionalities, wheel hub width adjustment, bicycle geometry adjustments and permitting passage of an endless drive belt and replacement of any damaged dropout with or without temporary deformation of bicycle frame tubes. This design doesn't require the contact of the junction between seat stay and chain stay in the assembled bicycle so passage of belt is facilitated.

FIG. 1 shows one embodiment of dropout and two ways of achieving hub wheel width adjustability. Further as shown in 4, FIG. 1 A, the junction face between dropout and mounting lug can be keyed to prevent relative rotation around the fastener axis. Having holes in the dropout at different vertical locations may allow bicycle frame height relative to ground to be adjusted. Similarly, having holes in the dropout at different horizontal locations may allow bicycle wheel to be displaced horizontally relative to crank axis or in other words enable variation in rear wheel crank axis distance. This in particular comes handy when adjustment is needed for a belt tension. The belt tension adjustment may also be taken care of by having elongated horizontal slots for fastening the dropout to the mounting lug. The horizontal adjustment, when beyond an adjustment threshold, may also allow for a belt of a different size, smaller or longer length to be installed. It is also possible to effect the vertical and horizontal displacements simultaneously. Here it is obvious that corresponding dropouts on the other side of the bicycle may have compatible hole configurations as the belt side dropouts of the bicycle to balance any vertical or horizontal adjustment due to the belt side dropouts.

Additionally, FIG. 1 B depicts a narrow hub setting shown to be, but not limited to (114 mm). Here the dropout is thicker and needs no spacer. Alternatively, FIG. 1 C depicts the same 114 mm setting achieved using thin dropout and one piece spacer. This spacer shown as 5 in FIG. 1, may or may not be keyed.

The different way of visualizing the same invention is that the replaceable dropout fastened to mounting lugs and another replaceable dropout on the other side of the can both be disengaged to accommodate a different rear wheel such that belt side replaceable dropout can be entirely replaced by another replaceable dropout to change the wheel hub width. In an additional detail, the wheel hub width change affected by replacement of dropouts on both sides of the bicycle allows change of the rear wheel by a symmetric rear wheel or asymmetric rear wheel. Alternatively, the wheel hub width change affected by only a replacement of one side dropout can enable a change of asymmetric rear wheel.

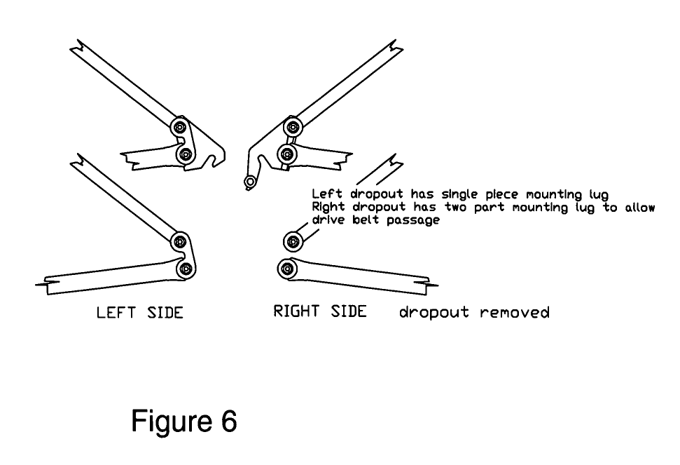

In yet another different setting, FIG. 1 D shows a wider (135 mm) hub setting with a thin dropout. Dropout on the left side as shown in FIG. 6 shares a similar design, with same range of adjustment as dropout on right side. Only difference being that the two piece lug design of the right side is not required on the left since the endless belt is always installed on the right side of the bicycle. Drop out can include various mounts for components including but not limited to disk brake callipers, drum brake reaction arms or derailleur' s.

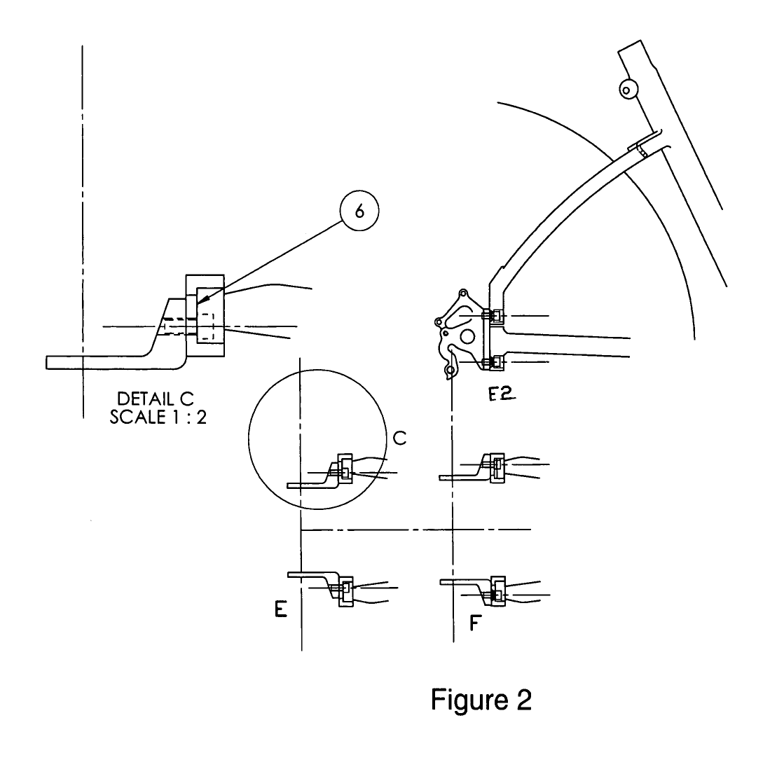

In another aspect of the invention, FIG. 2 shows an alternate type of dropout arrangements with different means of providing wheel hub width adjustments. This type of an arrangement needs no spacer or different dropout to change width. As in previous type, interface between the dropout and mounting lug can be keyed and different mounting holes on dropout may allow vertical adjustments. As shown in FIG. 2 Detail C, a dropout can be moved along elongated holes to accommodate a narrow hub. Alternatively, FIG. 2, F shows the same dropout set to greater width. As illustrated, 6 FIG. 2, and F2 FIG. 2, show a view of the assembly using square pyramidal locators.

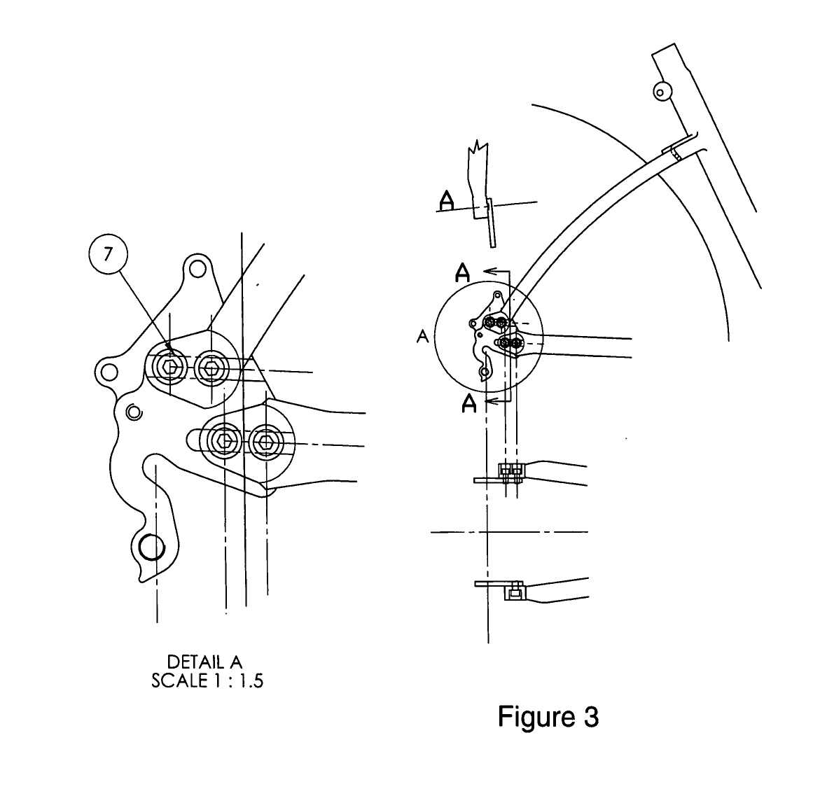

In another alternative scenario, FIG. 3 illustrates is a third type of dropout arrangement. Here, as shown by 7 FIG. 3, the dropout uses four fasteners instead of two to prevent relative rotation of the bicycle frame at interface. This type of dropout can also be keyed at interface.

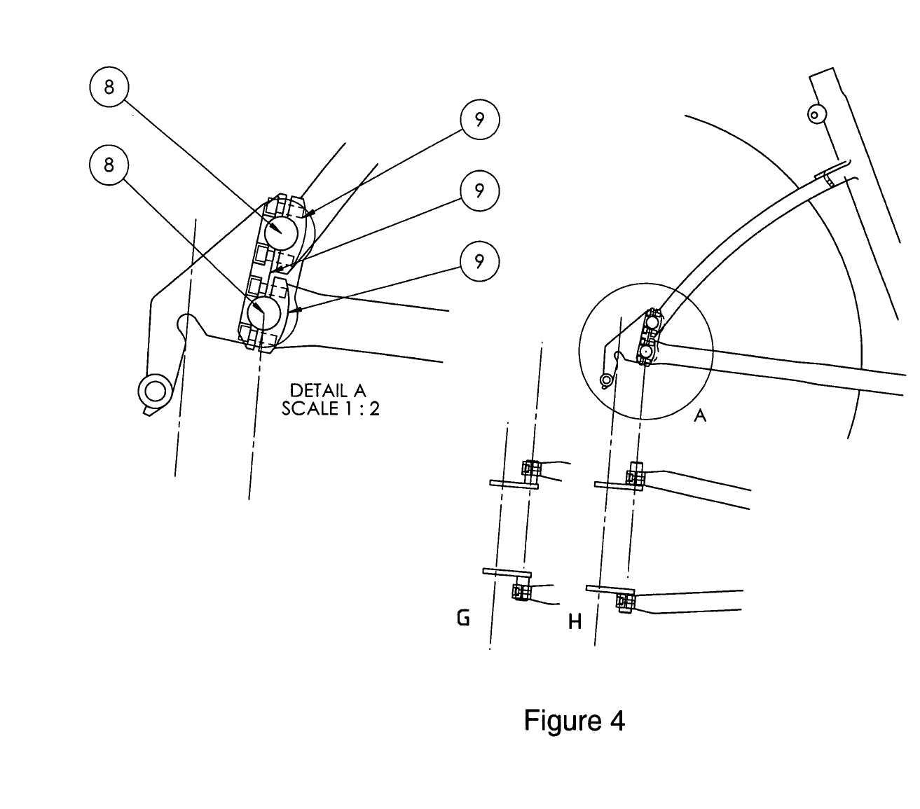

In another aspect of the invention, FIG. 4 shows another type of mount. This mount as shown by 8, FIG. 4, uses two round rods as part of the dropout and clamped to frame lug in a way that permits width adjustment when clamps as show by 9 FIG. 4 are opened. FIG. 4 G shows a narrow width setting and FIG. 4 H shows the dropout for wide setting by sliding on the two rods.

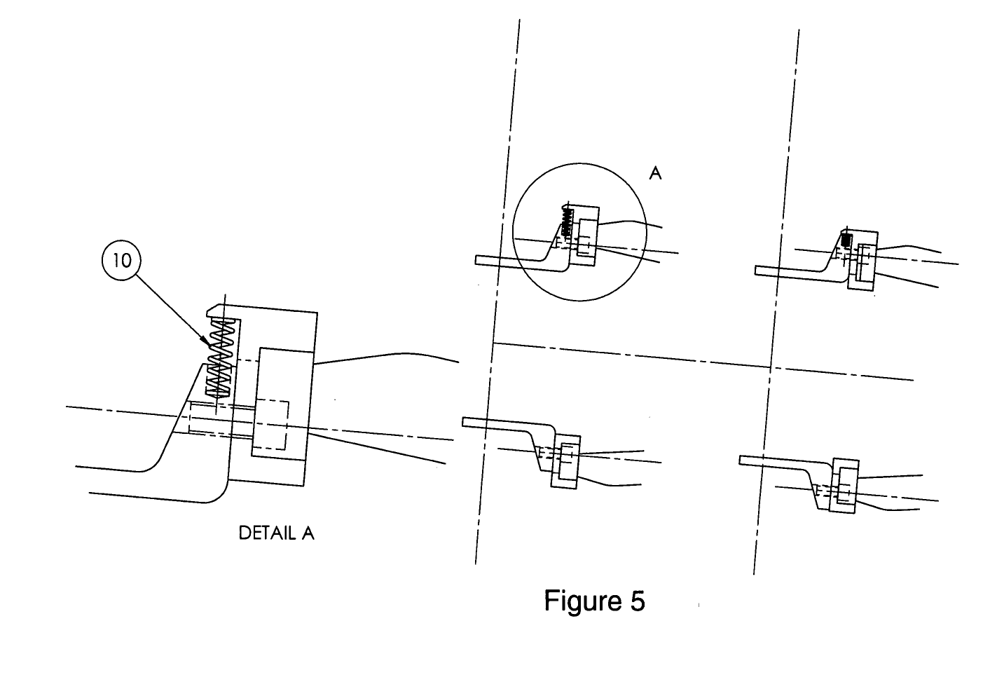

In another wheel hub adjustable width arrangement as shown by 10, FIG. 5, an extendable dropout is shown. The arrangement uses springs loaded width adjustments with bolts locking the assembly. The springs used may be rigid or a locking bolt maybe used to provide a fixed width while the bicycle is being used.

Although a form of the invention has been described herein, it will be obvious to those skilled in the art that variations may be made in the construction and relation of parts without departing from the spirit and scope of the invention described herein.

What is claimed is:

1. A portion of a bicycle assembly comprising a dropout system, the system comprising:
a first replaceable dropout fastened to mounting lugs wherein the first replaceable dropout can be entirely replaced by a second replaceable dropout of a different width to change a width of a wheel hub.

2. The assembly of claim 1, wherein the second replaceable dropout can be placed along with a spacer.

3. The assembly of claim 1, wherein the replaceable dropout allows temporary separation of bicycle frame tubes to permit passage of an endless drive belt.

4. The assembly of claim 1, wherein the first and second replaceable dropouts have holes at different vertical locations to enable a bicycle frame height relative to a crank axis to be adjusted.

5. The assembly of claim 1, wherein the first and second replaceable dropouts has horizontally elongated holes or holes at different horizontal locations to enable variation in rear wheel crank axis distance enabling endless belt tension to be adjusted.

6. The assembly of claim 1, wherein the first and second replaceable dropouts have horizontally elongated holes or holes at different horizontal locations to enable a bicycle frame to be displaced horizontally enabling endless belt tension to be adjusted and holes at different vertical locations to enable a bicycle frame height relative to the crank axis to be adjusted such that horizontal and vertical adjustments can take place simultaneously.

7. The assembly of claim 4, 5 or 6 wherein corresponding dropouts on another side of the bicycle have compatible hole configurations as a belt side dropouts of the bicycle to balance any vertical or horizontal adjustment due to the belt side dropouts.

8. The assembly of claim 1 wherein a keyed interface at a junction of the first or second replaceable dropout prevent rotation of the first or second replaceable dropout.

9. A portion of a bicycle assembly comprising a dropout system, the system comprising:
a replaceable dropout fastened to the mounting lugs wherein the first replaceable dropout can be moved along elongated holes to vary the width of the wheel hub.

10. A portion of a bicycle assembly comprising a dropout system, the system comprising:
the replaceable dropout fastened to the mounting lugs wherein the replaceable dropout uses two round rods that are part of the replaceable dropout and clamped to frame lug in a way that permits wheel hub width adjustment when clamps are opened.

11. A portion of a bicycle assembly comprising a dropout system, the system comprising:
a replaceable extendable dropout fastened to the mounting lugs wherein the replaceable extendable dropout uses springs loaded width adjustments with bolts locking the assembly to adjust the width of the wheel hub.

12. A portion of a bicycle assembly comprising a dropout system, the system comprising:
a first replaceable dropout fastened to mounting lugs wherein the first replaceable dropout can be unfastened to permit passage of an endless drive belt without deformation of bicycle frame tubes.

13. A portion of a bicycle assembly comprising a dropout system, the system comprising:
a first replaceable dropout fastened to mounting lugs wherein the first replaceable dropout can be entirely replaced by a second replaceable dropout wherein the first and second replaceable dropouts have horizontally elongated holes or holes at different horizontal locations to enable variation in rear wheel to crank axis distance enabling endless belt tension to be adjusted.

14. A portion of a bicycle assembly comprising a dropout system, the system comprising:
a first replaceable dropout fastened to mounting lugs wherein the two lugs can be placed separately on the dropout so as to leave an open gap between chain stay and seat stay lugs when the dropout is removed.

15. A portion of a bicycle assembly comprising a dropout system, the system comprising:
the first replaceable dropout fastened to mounting lugs and a third replaceable dropout on another side of the bicycle wherein the first replaceable dropout can be entirely replaced by the second replaceable dropout of a different width and the third replaceable dropout is replaced by a fourth replaceable dropout to accommodate a different symmetric rear wheel.
